(19) United States
(12) Patent Application Publication
(10) Pub. No.: US 2025/0065935 A1
(43) Pub. Date: Feb. 27, 2025

(54) TROLLEY FRAME

(71) Applicant: Hangzhou Zhengchuang Industrial Design Co., Ltd., Hangzhou (CN)

(72) Inventor: Xuefeng ZHENG, Hangzhou (CN)

(73) Assignee: Hangzhou Zhengchuang Industrial Design Co., Ltd., Hangzhou (CN)

(21) Appl. No.: 18/798,211

(22) Filed: Aug. 8, 2024

(30) Foreign Application Priority Data
Aug. 22, 2023 (CN) 2023222596435

(51) Int. Cl. B62B 3/02

(52) U.S. Cl. CPC B62B 3/025

(57) ABSTRACT

The disclosure relates to the technical field of trolleys, and in particular to a trolley frame, including four wheel carriers provided with roller wheels at lower ends and connected by a bottom folding stand. A side folding stand includes a support bar and at least two first X-shaped linkage assemblies. The support bar is arranged between the two first X-shaped linkage assemblies, and a lower end of the support bar is hinged to the bottom folding stand. A cloth bag can be well supported according to this solution, so as to reduce a risk of the cloth bag being damaged or torn in case of load bearing.

### CROSS-REFERENCE TO RELATED APPLICATIONS

The application claims priority to Chinese patent application No. 2023222596435, filed on Aug. 22, 2023, the entire contents of which are incorporated herein by reference.

### TECHNICAL FIELD

The disclosure relates to the technical field of trolleys, and in particular to a trolley frame.

### BACKGROUND

A trolley, as a handling tool, is widely used in daily life. The trolley mainly includes a frame and a bag. Generally, for the convenience of carrying, some frames in the related art are typically designed into a foldable structure.

For example, the patent document with Publication No. CN211710882U discloses a foldable and gatherable trolley. In this trolley, the assemblies of multiple surfaces and the draw bar assembly that constitute the frame assembly are all foldable. The folded trolley is small in size, which realizes the maximum folding and reduces the occupied space.

This type of trolley can be well folded, but still has defects in actual use. For example, typically, this type of trolley is used together with a bag, which is assembled on the frame. Specifically, the top of the bag needs to be connected to the side wall assemblies of the frame. However, in the frame described above, when the bag is connected to the side wall assemblies, the middle part of the side surface of the bag needs to be connected to the connection point between the tops of the two X-shaped linkage mechanisms in the side wall assembly, which is equivalent to supporting the bag at one point. As the middle part of the cloth bag is supported by this connection point, once the articles contained in the cloth bag are excessively heavy, the cloth bag will be easily damaged or torn at this connection point. As a result, it still needs to be improved.

### SUMMARY

In order to solve at least one of the technical problems mentioned in the BACKGROUND, an objective of the disclosure is to provide a trolley frame.

In order to achieve the above objective, the disclosure provides the following technical solution:

A trolley frame includes four wheel carriers provided with roller wheels at lower ends. Bottoms of the wheel carriers are connected by a bottom folding stand. Every two adjacent wheel carriers along a frame width direction are connected by an end folding stand. Every two adjacent wheel carriers along a frame length direction are connected by a side folding stand. The side folding stand includes a support bar and at least two first X-shaped linkage assemblies. The support bar is arranged between the two first X-shaped linkage assemblies, and a lower end of the support bar is hinged to the bottom folding stand. Two ends of a lower part of the first X-shaped linkage assembly are respectively hinged to the bottom of the wheel carrier and a bottom of the support bar, and of two ends of an upper part of the first X-shaped linkage assembly, one close to the wheel carrier is hinged with one end of a first horizontal bar, and the other close to the support bar is hinged with one end of a second horizontal bar. The other end of the first horizontal bar is hinged with a top of the wheel carrier. The other end of the second horizontal bar is hinged with a top of the support bar.

Compared with the prior art, this solution has the following advantages:

In this solution, the support bar is arranged between the two first X-shaped linkage assemblies, and the top of the support bar is hinged with the second horizontal bar. In this way, when the frame is unfolded for use, the middle part of the side wall of the cloth bag can be connected to the two second horizontal bars. In this case, the middle part of the side wall of the cloth bag can be supported by the two second horizontal bars, which is equivalent to supporting the cloth bag linearly rather than at a certain point. Compared with the existing method of supporting the cloth bag at certain points, the cloth bag can be better supported according to this solution, so as to reduce the risk of the cloth bag being damaged or torn in case of load bearing.

Preferably, the bottom folding stand includes two sets of X-shaped hinged bars. Each set of X-shaped hinged bars includes a middle connecting member and four fulcrum bars, and one end of each of the fulcrum bars is hinged to the middle connecting member. The other ends of two of the fulcrum bars are respectively hinged to the bottoms of the two wheel carriers, and the other ends of the other two fulcrum bars are respectively hinged to the lower ends of the two support bars.

Preferably, two sides of the lower end of the support bar are respectively provided with connecting lugs, and the fulcrum bars of the two sets of X-shaped hinged bars are respectively hinged to the two engaging lugs.

Preferably, the first X-shaped linkage assembly includes a first link and a second link, and the first link and the second link are crossed and hinged. One end of the first link is hinged to the bottom of the wheel carrier, and the other end is hinged with the second horizontal bar. One end of the second link is hinged with the first horizontal bar, and the other end is hinged with a lower part of the support bar.

Preferably, the end folding stand includes two third horizontal bars and at least one second X-shaped linkage assembly. Two ends of a lower part of the second X-shaped linkage assembly are respectively hinged to two of the wheel carriers, and two ends of an upper part of the second X-shaped linkage assembly are respectively hinged with one end of each of the two third horizontal bars. The other ends of the two third horizontal bars are respectively hinged to the two wheel carriers adjacent thereto.

Preferably, the second X-shaped linkage assembly includes a third link and a fourth link, and the third link and the fourth link are crossed and hinged. A lower end of the third link and a lower end of the fourth link are respectively hinged to the lower parts of two of the wheel carriers. An upper end of the third link and an upper end of the fourth link are respectively hinged with ends of the two third horizontal bars.

Other advantages and effects of the disclosure will be explained in detail in the detailed description and the accompanying drawings.

### BRIEF DESCRIPTION OF THE DRAWINGS

FIG. 1 is a schematic structural view of the disclosure in an unfolded state;

FIG. 2 is a front view of the disclosure in the unfolded state;

FIG. 3 is a top view of the disclosure in the unfolded state;

FIG. 4 is a schematic structural view of the disclosure in the folding process;

FIG. 5 is a schematic structural view of a support bar; and

FIG. 6 is a schematic structural view of the disclosure in a folded state.

### DETAILED DESCRIPTION OF THE EMBODIMENTS

The technical solution of the examples of the disclosure will be explained and illustrated with reference to the accompanying drawings, but the following examples are merely preferred examples, and not all the examples of the disclosure. All other examples obtained by those skilled in the art based on the examples in the embodiments without creative work shall fall within the protection scope of the disclosure.

In the following description, terms that indicate the orientation or positional relationship, such as “inner”, “outer”, “upper”, “lower”, “left” and “right”, are merely for the convenience of describing the examples and simplifying the description, rather than for indicating or implying that the device or element referred to must have a particular orientation or be constructed and operated in a particular orientation, and therefore, should not be construed as a limitation of the disclosure.

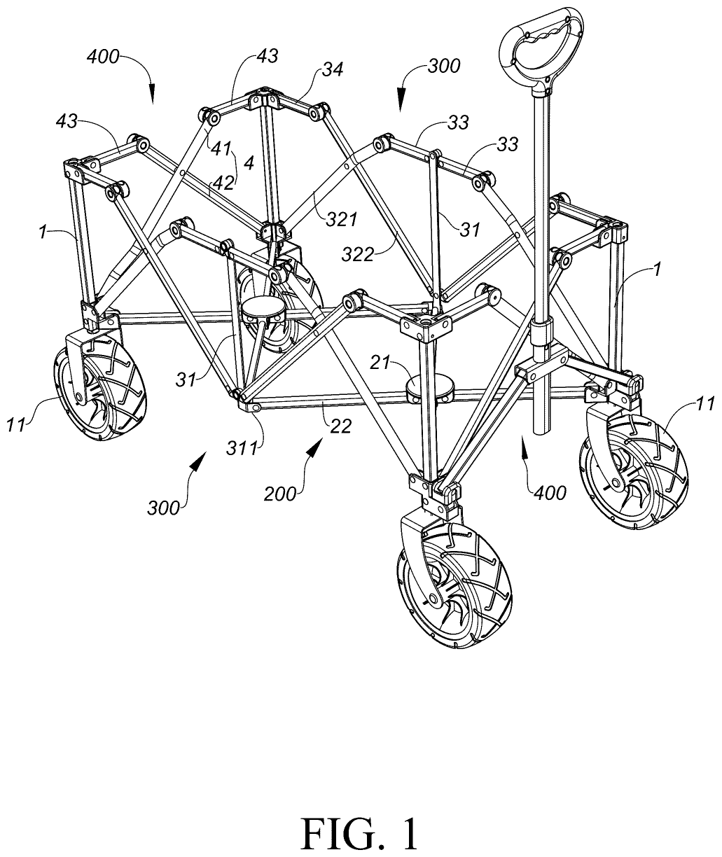

Referring to FIG. 1 to FIG. 6, this example provides a trolley frame, including four wheel carriers 1 provided with roller wheels 11 at lower ends. Every two of the four wheel carriers 1 are arranged opposite to each other.

It can be understood that a trolley generally includes a frame and a bag. The bag is assembled on the frame, and mainly used for containing articles to be transported.

Bottoms of the wheel carriers 1 are connected by a bottom folding stand. The bottom folding stand is mainly used for supporting a bottom of the bag. It can be understood that the bottom folding stand is a foldable structure, which can be folded vertically or unfolded outward.

As shown in FIG. 1, every two adjacent wheel carriers 1 along a frame width direction are connected by an end folding stand 400. It can be understood that there are two end folding stands 400, which are respectively arranged at front and rear ends of the frame to form a front wall and a rear wall of the frame.

Every two adjacent wheel carriers 1 along a frame length direction are connected by a side folding stand 300. Similarly, there are two side folding stands 300, which are respectively arranged at two sides of the frame to form two side walls of the frame.

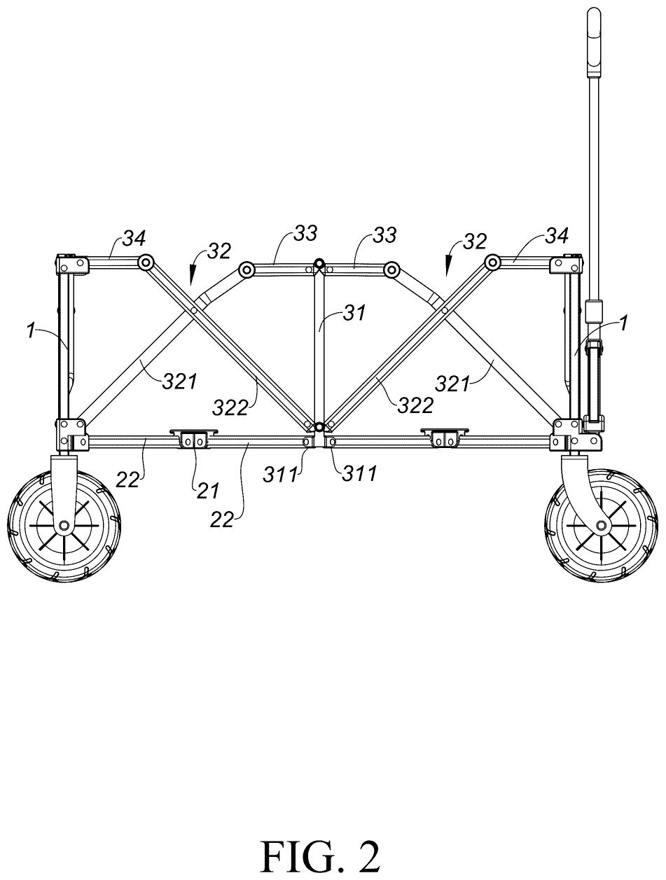

As shown in FIG. 1 and FIG. 2, the side folding stand 300 includes a support bar 31 and at least two first X-shaped linkage assemblies 32. For example, this example specifically shows the case where two first X-shaped linkage assemblies 32 are used, and the two first X-shaped linkage assemblies 32 are sequentially arranged along the frame length direction. The first X-shaped linkage assembly 32 forms two upper ends and two lower ends.

The support bar 31 is basically arranged vertically, and arranged between the two first X-shaped linkage assemblies 32. A lower end of the support bar 31 is hinged to the bottom folding stand, so that the support bar 31 and the bottom folding stand can move relative to each other.

The specific connecting structure of the bottom folding stand and the support bar 31 is as follows:

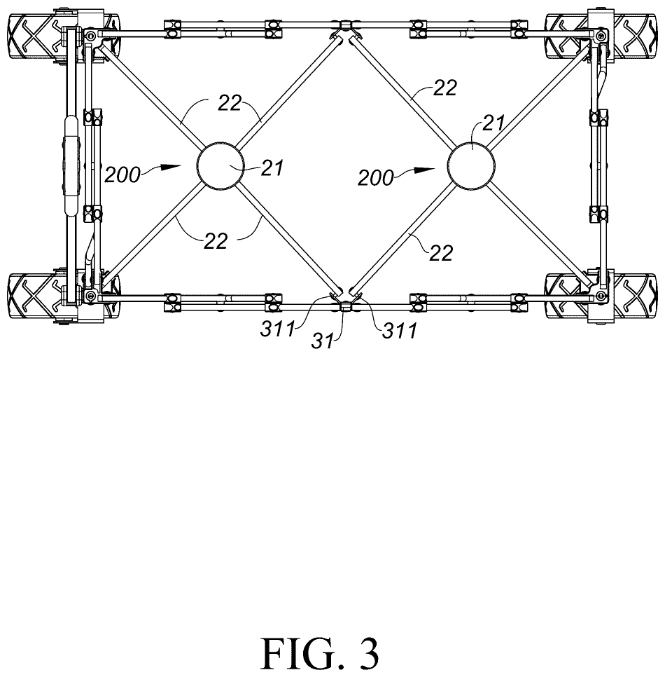

As shown in FIG. 1 and FIG. 3, the bottom folding stand includes two sets of X-shaped hinged bars 200. Each set of X-shaped hinged bars 200 includes a middle connecting member 21 and four fulcrum bars 22. One end of each of the fulcrum bars 22 is hinged to the middle connecting member 21, so that the fulcrum bars 22 can flip up and down relative to the middle connecting member 21 so as to be folded or unfolded.

The other ends of two of the fulcrum bars 22 are respectively hinged to the bottoms of the two wheel carriers 1, and the other ends of the other two fulcrum bars 22 are respectively hinged to the lower ends of the two support bars 31.

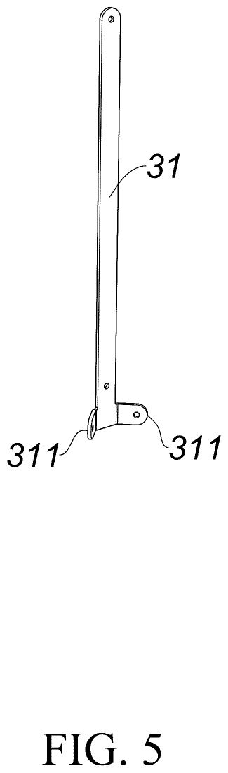

In order to make the lower end of the support bar 31 be hinged with the ends of the two fulcrum bars 22 in both of the two sets of X-shaped hinged bars 200, as shown in FIG. 5, two sides of the lower end of the support bar 31 are respectively provided with connecting lugs 311, and the fulcrum bars 22 of the two sets of X-shaped hinged bars 200 are respectively hinged to the two engaging lugs 311, as shown in FIG. 1 and FIG. 3.

Two ends of a lower part of the first X-shaped linkage assembly 32 are respectively hinged to the bottom of the wheel carrier 1 and a bottom of the support bar 31.

As shown in FIG. 1 and FIG. 2, the side folding stand 300 further includes two first horizontal bars 34 and two second horizontal bars 33. The two first horizontal bars 34 are respectively connected to the first X-shaped linkage assemblies 32. Similarly, the two second horizontal bars 33 are also respectively connected to the two first X-shaped linkage assemblies 32. Specifically:

Of two ends of an upper part of the first X-shaped linkage assembly 32, one close to the wheel carrier 1 is hinged with one end of the first horizontal bar 34, and the other close to the support bar 31 is hinged with one end of the second horizontal bar 33. The other end of the first horizontal bar 34 is hinged with a top of the wheel carrier 1. The other end of the second horizontal bar 33 is hinged with a top of the support bar 31. Preferably, axes of rotation of the two second horizontal bars 33 on the support bar 31 coincide. In addition, when the frame is unfolded, the first horizontal bars 34 and the second horizontal bars 33 are basically horizontal.

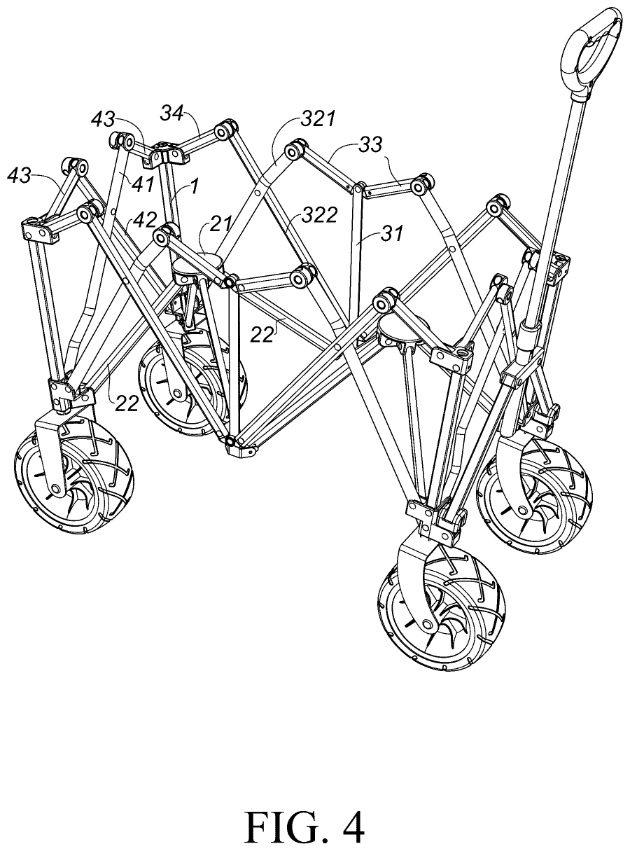

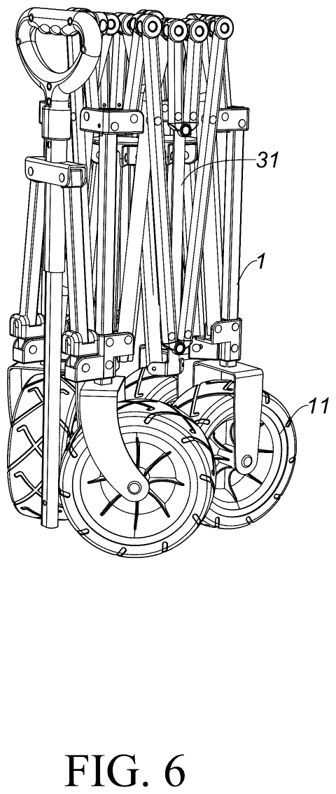

With the above arrangement, the whole frame may be in a folded state or an unfolded state. When the frame is in the unfolded state, as shown in FIG. 1, the bottom folding stand, the side folding stands 300 and the end folding stands 400 are all unfolded, and in this case, the whole frame exhibits a frame structure. When the frame is folded, as shown in FIG. 4, the side folding stands 300 are gathered and folded along the frame length direction, the end folding stands 400 are gathered and folded along the frame width direction, and the bottom folding stand is gathered to the middle. In this way, the whole frame is in the folded state, exhibiting a bundle structure (as shown in FIG. 6), thereby reducing the occupied space.

In this example, the support bar 31 is arranged between the two first X-shaped linkage assemblies 32, and the top of the support bar 31 is hinged with the second horizontal bar 33. In this way, when the frame is unfolded for use, the middle part of the side wall of the cloth bag can be connected to the two second horizontal bars 33. In this case, the middle part of the side wall of the cloth bag can be supported by the two second horizontal bars 33, which is equivalent to supporting the cloth bag linearly rather than at a certain point. Compared with the existing method of supporting the cloth bag at certain points, the cloth bag can be better supported according to this solution, so as to reduce the risk of the cloth bag being damaged or torn in case of load bearing.

Since the structures of the two first X-shaped linkage assemblies 32 are basically the same, in this example, one of the first X-shaped linkage assemblies will be specifically described as an example:

As shown in FIG. 2, the first X-shaped linkage assembly 32 includes a first link 321 and a second link 322. The first link 321 and the second link 322 are crossed and hinged. One end of the first link 321 is hinged to the bottom of the wheel carrier 1, and the other end is hinged with the second horizontal bar 33. One end of the second link 322 is hinged with the first horizontal bar 34, and the other end is hinged with a lower part of the support bar 31. Preferably, axes of rotation of the two second links 322 in the two first X-shaped linkage assemblies 32 on the support bar 31 coincide.

As shown in FIG. 1, the end folding stand 400 includes two third horizontal bars 43 and at least one second X-shaped linkage assembly 4. For example, this example shows the case where 1 second X-shaped linkage assembly 4 is used:

The second X-shaped linkage assembly 4 respectively forms two ends at upper and lower sides. The two ends of the lower part of the second X-shaped linkage assembly 4 are respectively hinged to the two wheel carriers 1, and the two ends of the upper part of the second X-shaped linkage assembly 4 are respectively hinged with one end of each of the two third horizontal bars 43. The other ends of the two third horizontal bars 43 are respectively hinged to the two wheel carriers 1 adjacent thereto. Preferably, when the frame is in the unfolded state, the third horizontal bars 43 are basically horizontal.

The specific structure of the second X-shaped linkage assembly 4 is as follows:

As shown in FIG. 1, the second X-shaped linkage assembly 4 includes a third link 41 and a fourth link 42. The third link 41 and the fourth link 42 are crossed and hinged. A lower end of the third link 41 and a lower end of the fourth link 42 are respectively hinged to the lower parts of two of the wheel carriers 1. An upper end of the third link 41 and an upper end of the fourth link 42 are respectively hinged with ends of the two third horizontal bars 43.

For those skilled in the art, it is apparent that the disclosure is not limited to the details of the above exemplary examples, and the disclosure can be implemented in other specific forms without departing from the spirit or basic features of the disclosure. Therefore, from any point of view, the examples should be regarded as exemplary and non-limiting. The scope of the disclosure is defined by the appended claims rather than the description above, and therefore, it is intended that all changes falling within the meaning and scope of equivalent elements of the claims are included in the disclosure.

What is claimed is:

1. A trolley frame, comprising four wheel carriers provided with roller wheels at lower ends, wherein bottoms of the wheel carriers are connected by a bottom folding stand; every two adjacent wheel carriers along a frame width direction are connected by an end folding stand; every two adjacent wheel carriers along a frame length direction are connected by a side folding stand; the side folding stand comprises a support bar and at least two first X-shaped linkage assemblies, the support bar being arranged between the two first X-shaped linkage assemblies, and a lower end of the support bar being hinged to the bottom folding stand; two ends of a lower part of the first X-shaped linkage assembly are respectively hinged to the bottom of the wheel carrier and a bottom of the support bar, and of two ends of an upper part of the first X-shaped linkage assembly, one close to the wheel carrier is hinged with one end of a first horizontal bar, and the other close to the support bar is hinged with one end of a second horizontal bar; the other end of the first horizontal bar is hinged with a top of the wheel carrier; and the other end of the second horizontal bar is hinged with a top of the support bar.

2. The trolley frame according to claim 1, wherein the bottom folding stand comprises two sets of X-shaped hinged bars, each set of X-shaped hinged bars comprising a middle connecting member and four fulcrum bars, and one end of each of the fulcrum bars being hinged to the middle connecting member; wherein the other ends of two of the fulcrum bars are respectively hinged to the bottoms of the two wheel carriers, and the other ends of the other two fulcrum bars are respectively hinged to the lower ends of the two support bars.

3. The trolley frame according to claim 2, wherein two sides of the lower end of the support bar are respectively provided with connecting lugs, and the fulcrum bars of the two sets of X-shaped hinged bars are respectively hinged to the two engaging lugs.

4. The trolley frame according to claim 1, wherein the first X-shaped linkage assembly comprises a first link and a second link, and the first link and the second link are crossed and hinged; one end of the first link is hinged to the bottom of the wheel carrier, and the other end is hinged with the second horizontal bar; and one end of the second link is hinged with the first horizontal bar, and the other end is hinged with a lower part of the support bar.

5. The trolley frame according to claim 1, wherein the end folding stand comprises two third horizontal bars and at least one second X-shaped linkage assembly, two ends of a lower part of the second X-shaped linkage assembly being respectively hinged to two of the wheel carriers, and two ends of an upper part of the second X-shaped linkage assembly being respectively hinged with one end of each of the two third horizontal bars; and the other ends of the two third horizontal bars are respectively hinged to the two wheel carriers adjacent thereto.

6. The trolley frame according to claim 5, wherein the second X-shaped linkage assembly comprises a third link and a fourth link, and the third link and the fourth link are crossed and hinged; a lower end of the third link and a lower end of the fourth link are respectively hinged to the lower parts of two of the wheel carriers; and an upper end of the third link and an upper end of the fourth link are respectively hinged with ends of the two third horizontal bars.
